(19) United States
(12) Patent Application Publication
(10) Pub. No.: US 2025/0378017 A1
(43) Pub. Date: Dec. 11, 2025

(54) FILE SYSTEM WITH TAGGED CAPACITY FOR MEMORY DEVICE

(71) Applicant: MICRON TECHNOLOGY, INC., Boise, ID (US)

(72) Inventor: John M. Groves, Austin, TX (US)

(21) Appl. No.: 19/211,799

(22) Filed: May 19, 2025

Related U.S. Application Data
(60) Provisional application No. 63/657,205, filed on Jun. 7, 2024.

(51) Int. Cl. G06F 12/02

(52) U.S. Cl. CPC G06F 12/023; G06F 2212/1048

(57) ABSTRACT

A system can include a memory device comprising a plurality of dynamic capacity devices and a processing device, operatively coupled with the memory device. The processing device is configured to perform operations including sending, to a memory device, an allocation request to allocate, for a file system, a first memory section of a plurality of memory sections of a plurality of dynamic capacity devices associated with the memory device; reserving, for the file system, a first portion of the first memory section for storing file metadata of file system data; reserving, for the file system, a second portion of the first memory section for storing file data of file system data; sending, by a first process running on the host system, to the memory device, the file metadata for storing the file metadata in the first portion of the first memory section; sending, by a second process running on the host system, to the memory device, a second request to modify the file metadata stored in the first portion of the first memory section; and receiving, from the memory device, a second response indicating an error regarding the second request.

### RELATED APPLICATIONS

This application claims the benefit of U.S. Provisional Patent Application No. 63/657,205, filed Jun. 7, 2024, the entire contents of which are incorporated by reference herein.

### TECHNICAL FIELD

Embodiments of the disclosure relate generally to memory sub-systems, and more specifically, relate to implementing a file system with tagged capacity in a memory device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is a block diagram of an example system for implementing a file system with tagged capacity in a compute express link (CXL) memory device in accordance with some embodiments of the present disclosure.

FIGS. 3A-3B illustrate example formats of a file system with tagged capacity in accordance with some embodiments of the present disclosure.

FIG. 4 illustrates an example of tag mapping data structure in accordance with some embodiments of the present disclosure.

FIG. 5 is a flow diagram of an example method for implementing a file system with tagged capacity in a compute express link (CXL) memory device in accordance with some embodiments of the present disclosure.

FIG. 6 is a block diagram of an example computer system in which embodiments of the present disclosure may operate.

### DETAILED DESCRIPTION

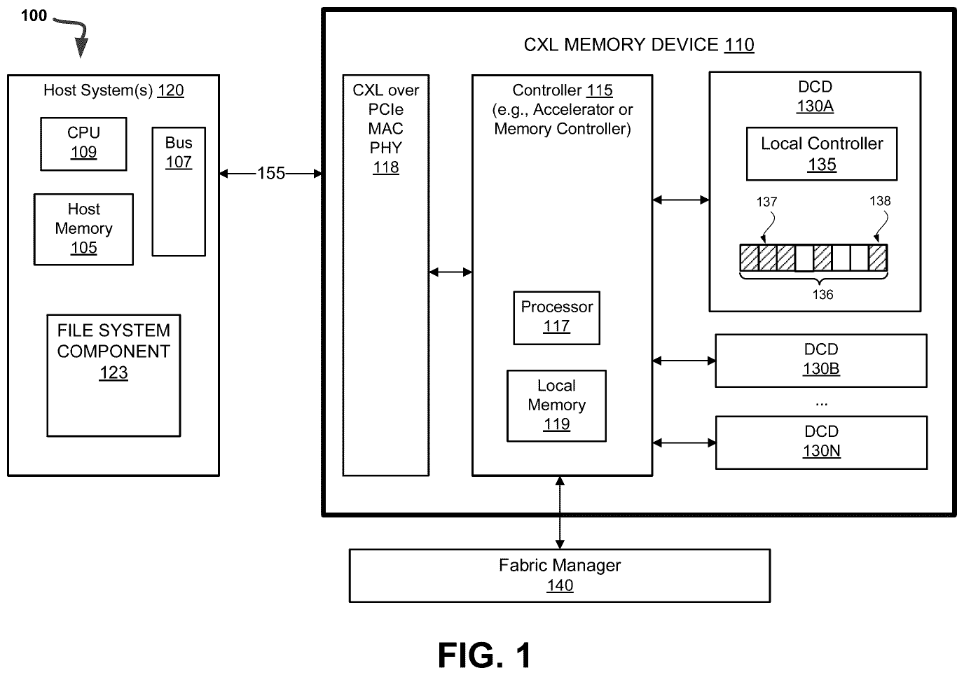

Aspects of the present disclosure are directed to implementing a file system with tagged capacity in a memory device. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A compute express link (CXL) system is an optionally cache-coherent interconnect for processors, memory expansion, and accelerators. A CXL system maintains memory coherency between the CPU memory space and memory on attached devices, which allows resource sharing for higher performance, reduced software stack complexity, and lower overall system cost. Generally, CXL is an interface standard that can support a number of protocols that can run on top of PCIe, including a CXL.io protocol, a CXL.mem protocol and a CXL.cache protocol. The CXL.io protocol is a PCIe-like protocol that can be viewed as an “enhanced” PCIe protocol capable of carving out managed memory. CXL.io can be used for initialization, link-up, device discovery and enumeration, register access, and can provide an interface for I/O devices. The CXL.mem protocol can enable host access to the memory of an attached device using memory semantics (e.g., load and store commands). This approach can support both volatile and persistent memory architectures. The CXL.cache protocol can define host-device interactions to enable efficient caching of host memory with low latency using a request and response approach. Traffic (e.g., NVMe traffic) can run through the CXL.io protocol, and the CXL.mem and CXL.cache protocols can share a common link layer and transaction layer. Accordingly, the CXL protocols can be multiplexed and transported via a PCIe physical layer.

A memory device that supports CXL protocols and can be attached to a host via CXL is referred to as a CXL memory device, which can provide additional bandwidth and capacity to host processors. The CXL memory device is independent of the host memory. In some implementations, the CXL memory device may partition resources into multiple logical devices, and each logical device can be visible as a memory device. In some implementations, the CXL memory device may support multiple host systems. A fabric manager may configure resource allocation for multiple host systems across the logical devices. Dynamic capacity (DC) is a feature of a CXL memory device that allows exposed memory capacity to be allocated and freed dynamically without the need for resetting the CXL memory device. Although the CXL memory device is used here as an illustrative example for implementing the dynamic capacity, the dynamic capacity feature can be applied to other memory devices.

Specifically, a dynamic capacity device (DCD) is a memory device, such as a CXL memory device, with a built-in allocator and access control that implements dynamic capacity (DC). A device physical address (DPA) range of a DCD can be subdivided into several regions (e.g., 1 to 8 regions) and each of these regions may be further subdivided into a set of blocks. The fabric manager can allocate one or more blocks to a host system and associate the block(s) with a tag, where the block(s) can be referred to as a taggable DC unit. The taggable DC unit may represent a management unit that can be tagged, assigned in various capacity size, and dynamically allocated to various host systems. A taggable DC unit that has been assigned with a tag is referred to as a tagged capacity unit. Each tag is globally unique, and thus the tags associated with the taggable DC units can form an aggregate tag space in the memory device, such as the CXL memory device, and each tag in the aggregate tag space is uniquely identifiable. Each tag can be associated with one or more host systems and may be mapped to one or more DPA ranges (e.g., a set of one or more contiguous physical address ranges or physical address extent-lists (i.e., non-contiguous address ranges) that identify respective locations storing the data on the DCDs). Each tag may be shareable or not.

Specifically, the fabric manager controls the allocation of these taggable DC units to one or more host systems (or a group of host systems) and utilizes events to signal the host systems when changes to the allocation of these taggable DC units occurs. The fabric manager also assigns a tag to the allocated taggable DC units by associating, in a tag mapping data structure, the tag with the taggable DC units represented by one or more physical addresses (e.g., one or more DPA ranges). The memory device maps the DPA ranges to the taggable DC units. The tag can thus be referred to as representing the tagged capacity units. The host system can map these DPA ranges to corresponding host physical address (HPA) ranges within the host address space available to the host system. In some implementations, the memory device may communicate the state of these tagged capacity units through an extent list that describes the starting DPA and length of all blocks the host system can access, where the extent list is managed by the memory device. The host system (or fabric manager on behalf of the host system) may use a set of commands for querying and configuring the tagged capacity units. The set of commands may include a command allocating the new tagged capacity units (e.g., Initiate Dynamic Capacity Add command), a command releasing the tagged capacity units (e.g., Initiate Dynamic Capacity Release command), and getting information of the tagged capacity units. The capacity of the sharable tagged capacity units associated with a tag and allocated to a host system is immutable such that no additional capacity can be added to the tag, nor can capacity be deleted from the tag. That is, although the content stored in the tagged capacity units can be modified, the mapping between the tag and the tagged capacity units allocated to the host system cannot be modified through the life of the sharable tag. A host system is thus required to request re-allocation for different capacities of tagged capacity units or for different tags being associated. In addition, the capacity of the sharable tagged capacity units is usually larger and does not suit to store smaller data sets. Further, the shared tagged capacity units cannot be used by a file system in the host system because such file system (e.g., Filesystem Direct Access (FSDAX) file system) usually does not support shared access. A file system is a hierarchy of directories (e.g., represented by a directory tree) that may be employed to organize files on a computer system.

Aspects of the present disclosure address the above and other deficiencies by implementing a file system with tagged capacity in compute express link (CXL) memory devices. A file system with tagged capacity enables a host system to manage file system data stored in a tagged capacity unit and supports one producer and multiple consumers as described below. The file system data can include file data, file metadata (e.g., access logs), directory structure, free space manager, and other data structures (or objects) capable of packaging data/metadata and being written to the CXL memory device. In some implementations, the file system data can represent data of one or more file system objects, including file system object data and file system object metadata. The file system object data can be the content of the file system object and may be generated by operating systems and/or applications running on the operating systems. The file system object metadata can be information about the file system object and may be generated for purposes of organization of files and allocation of memory space in the CXL memory devices.

Specifically, a process running on a host system (such process referred to as a “producer”), through a file system component (e.g., a user space driver) running on a host system may create a file system with tagged capacity by requesting allocation of a shared memory space of the DCDs to the host system for storing the file system data and storing certain portions of file system data in certain regions of the allocated memory space. For example, the file system component may configure a region to store metadata (referred to as “superblock,” e.g., at the beginning of the memory space) (“superblock region”), which describes the layout of the rest of the memory space, and store in the superblock region information to identify the producer (e.g., a unique identifier) and verify that this memory space is implemented with a file system with tagged capacity (e.g., magic number). The file system component may reserve a region to store file system object metadata (“metadata region”) and a region to store file system object data (“data region”). The metadata region may be used in a format of log, where the log contains multiple entries, and each entry can point to a position in the data region such that the file system object data stored at the position can be accessed.

Requesting allocating the memory space of the DCDs may involve requesting the controller of the CXL memory device and/or the fabric manager to determine an available memory space, for example, in a pre-defined size, of the DCDs to be allocated to the host system and assign a tag to the allocated memory space (referred to as the file system (FS) tagged capacity unit). The controller may store, in the tag mapping data structure, the tag, the DPA ranges of the allocated memory space of the DCDs, and the host identifier (or a host group identifier) that defines the host system(s) that can access the tag.

In some implementations, the file system component (e.g., under the request from the producer) may create a mount point (e.g., directories) for the file system with the tagged capacity. In some implementations, the file system component may mount the file system with the tagged capacity through the mount point so that a host system can access the file system to write or read data.

Upon creating and mounting the file system, the producer, through the file system component, may add file system data including file system object metadata and file system object data. The producer may send a write request to add file system data in the created file system. Adding file system data may include creating an entry (i.e., file system object metadata) in the log in the second region and writing file system object data in the third region. It is noted that adding file system data means writing new file system object metadata and corresponding new file system object data, but cannot be modifying existing file system object metadata. After this writing, the producer cannot modify the file metadata that has been written. This file metadata also cannot be modified by another process, such as another process running on the same or different host system, or the same process after unmounting and remounting the file system (such process referred to as a “consumer”). As such, a producer creates file system object metadata stored in the FS tagged capacity unit, while a consumer can only read the file system object metadata. Therefore, both the producer and the consumer cannot modify the file system object metadata once it is created, but both the producer and the consumer may modify the file system object data (e.g., the content of the files). This approach allows multiple processes to read the file system object metadata (shared memory) without the concern that the file system object metadata is being modified in the caches of one or more processes (“dirty”).

Advantages of the present disclosure include efficient management of data stored in the tagged capacity units allocated to a host system by using a file system with tagged capacity. The file system with tagged capacity can be compatibly used by existing systems that know how to use a file system. The file system with tagged capacity can also be used to subdivide the tagged capacity so that the memory space is more efficiently used. Further, the system significantly improves flexibility in using the tagged capacity.

FIG. 1 illustrates an example computing system 100 that includes a compute express link (CXL) memory device 110 in accordance with some embodiments of the present disclosure. The CXL memory device 110 can include media, such as one or more volatile memory devices, one or more non-volatile memory devices, or a combination of such.

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include one or more host system(s) 120 that are coupled to the CXL memory device 110. In some embodiments, the host system 120 is coupled to multiple CXL memory devices 110 of different types. FIG. 1 illustrates one example of a host system 120 coupled to one CXL memory device 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the CXL memory device 110, for example, to write data to the CXL memory device 110 and read data from the CXL memory device 110.

The host system 120 can be coupled to the CXL memory device 110 via a peripheral component interconnect express (PCIe) interface. The PCIe interface is a physical host interface used to transmit data between the host system 120 and the CXL memory device 110 for passing control, address, data, and other signals between the CXL memory device 110 and the host system 120. The host system 120 can further utilize a CXL interface to access components of the CXL memory device 110 when the CXL memory device 110 is coupled with the host system 120 by the physical host interface (e.g., PCIe bus). FIG. 1 illustrates a CXL memory device 110 as an example. In general, the host system 120 can access multiple CXL memory devices 110 via a same communication connection, multiple separate communication connections, and/or a combination of communication connections.

In some embodiments, the host system 120 includes a central processing unit (CPU) 109 connected to a host memory 105, such as DRAM or other main memories. The host system 120 includes a bus 107, such as a memory device interface, which interacts with a host interface 118, via a CXL connection 155.

The CXL connection 155 can include a set of data-transmission lanes (“lanes”) for implementing CXL protocols, including CXL.io protocol, CXL.mem protocol, and CXL.cache protocol. The CXL connection 155 can include any suitable number of lanes in accordance with the embodiments described herein. For example, the CXL connection 155 can include 16 lanes (i.e., CXL x16).

The host interface 118 may include media access control (MAC) and physical layer (PHY) components, of CXL memory device 110 for ingress of communications from host system 120 to CXL memory device 110 and egress of communications from CXL memory device 110 to host system 120. Bus 107 and host interface 118 operate under a communication protocol, such as a CXL over PCIe serial communication protocol or other suitable communication protocols. Other suitable communication protocols include Ethernet, serial attached SCSI (SAS), serial AT attachment (SATA), any protocol related to remote direct memory access (RDMA) such as Infiniband, iWARP, or RDMA over Converged Ethernet (RoCE), and other suitable serial communication protocols.

The computing system 100 may be a cache-coherent interconnect for processors, memory expansion, and accelerators. The computing system 100 maintains memory coherency between the CPU memory space and memory on attached devices, which allows resource sharing for higher performance, reduced software stack complexity, and lower overall system cost. Generally, CXL is an interface standard that can support a number of protocols that can run on top of PCIe, including a CXL.io protocol, a CXL.mem protocol and a CXL.cache protocol. The CXL.io protocol is a PCIe-like protocol that can be viewed as an “enhanced” PCIe protocol capable of carving out managed memory. CXL.io can be used for initialization, link-up, device discovery and enumeration, register access, and can provide an interface for I/O devices. The CXL.mem protocol can enable host access to the memory of an attached device using memory semantics (e.g., load and store commands). This approach can support both volatile and persistent memory architectures. The CXL.cache protocol can define host-device interactions to enable efficient caching of host memory with low latency using a request and response approach. Traffic (e.g., NVMe traffic) can run through the CXL.io protocol, and the CXL.mem and CXL.cache protocols can share a common link layer and transaction layer. Accordingly, the CXL protocols can be multiplexed and transported via a PCIe physical layer.

The CXL memory device 110 is a memory device that allows the host system 120 to use it for memory bandwidth expansion, memory capacity expansion, and persistent memory applications, and as small-scale resource pooling, and large-scale resource pooling and sharing.

In some implementations, the CXL memory device may be a multiple logical device (MLD), which may partition resources into multiple logical devices, and each logical device can be visible as a memory device. One of multiple logical devices can be reserved for a fabric manager to configure resource allocation across the logical devices, while the other logical devices can be available for assigning to the host. In some implementations, the CXL memory device may be a device that supports multiple host systems and may be referred to as fabric-attached memory (FAM). In the context of these computing environments, the term “fabric” can refer to interconnected communication paths that route signals on major components of a chip or between chips of a computing system. This “fabric” can form the architecture of interconnections between processing or compute nodes within a computing device or between multiple computing devices. In this context, processing nodes and compute nodes refer to processing devices operating as nodes on an interconnected network. Fabric-attached memory can refer to a memory architecture in which the memory is connected to the CPU through a fabric interconnect, rather than being directly connected to the CPU. This allows for the memory to be located at a distance from the CPU and can provide benefits such as improved scalability and fault tolerance. For example, in some systems, the fabric includes a bus or a set of connections that connect the processing device of the system to peripheral devices and other processing devices. In other systems, the fabric can also include a set of network connections between combinations of respective compute nodes and memory nodes. In various systems, the fabric acts as an interconnect to create a network of interconnected devices that work together as a single entity.

This unified framework incorporates many interconnected devices via the fabric (i.e., like many threads woven together to create a cohesive whole) to provide fast and reliable communication between the devices. In this context, an “interconnect” can refer to a device or system that connects multiple devices or subsystems together to allow them to communicate and exchange data.

The CXL memory device 110 can include a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The CXL memory device 110 can include any combination of the different types of non-volatile memory devices and/or volatile memory devices. The volatile memory devices can be, but are not limited to, random access memory (RAM), such as dynamic random access memory (DRAM) and synchronous dynamic random access memory (SDRAM). Some examples of non-volatile memory devices include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

The DCD 130A-130N can include volatile memory devices including, random access memory (RAM), such as dynamic random access memory (DRAM) and synchronous dynamic random access memory (SDRAM), and non-volatile memory devices including a not-and (NAND) type flash memory and write-in-place memory, such as a 3D cross-point memory device, which is a cross-point array of non-volatile memory cells, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A CXL memory device controller 115 can communicate with the DCD 130A-130N to perform operations such as reading data, writing data, or erasing data at the DCD 130A-130N and other such operations. The CXL memory device controller 115 can include hardware such as one or more integrated circuits and/or discrete components, a buffer memory, or a combination thereof. The hardware can include a digital circuitry with dedicated (i.e., hard-coded) logic to perform the operations described herein. The CXL memory device controller 115 can be a microcontroller, special purpose logic circuitry (e.g., a field programmable gate array (FPGA), an application specific integrated circuit (ASIC), etc.), or other suitable processors.

The CXL memory device controller 115 can include a processing device, which includes one or more processors (e.g., processor 117), configured to execute instructions stored in a local memory 119. In the illustrated example, the local memory 119 of the CXL memory device controller 115 includes an embedded memory configured to store instructions for performing various processes, operations, logic flows, and routines that control operation of the CXL memory device 110, including handling communications between the CXL memory device 110 and the host system 120. The CXL memory device controller 115 may manage operations of CXL memory device 110, such as writes to and reads from DCD 130A-130N. The CXL memory device controller 115 may include one or more processors 117, which may be multi-core processors. Processors 117 can handle or interact with the components of DCD 130A-130N, generally through firmware code. The CXL memory device controller 115 may operate under CXL protocol, but other protocols are applicable.

The CXL memory device controller 115 executes computer-readable program code (e.g., software or firmware) executable instructions (herein referred to as “instructions”). The instructions may be executed by various components of CXL memory device controller 115, such as processor 117, logic gates, switches, application specific integrated circuits (ASICs), programmable logic controllers, embedded microcontrollers, and other components of CXL memory device controller 115. The instructions executable by the CXL memory device controller 115 for carrying out the embodiments described herein are stored in a non-transitory computer-readable storage medium. In certain embodiments, the instructions are stored in a non-transitory computer readable storage medium of CXL memory device 110, such as DCD 130A-130N. Instructions stored in the CXL memory device 110 may be executed without added input or directions from the host system 120. In other embodiments, the instructions are transmitted from the host system 120. The CXL memory device controller 115 is configured with hardware and instructions to perform the various functions described herein and shown in the figures.

The CXL memory device controller 115 may interact with DCD 130A-130N for read and write operations. The CXL memory device controller 115 may execute the direct memory access (DMA) for data transfers between host system 120 and DCD 130A-130N without involvement from CPU 109. The CXL memory device controller 115 may control the data transfer while activating the control path for fetching commands, posting completion and interrupts, and activating the DMA for the actual data transfer between host system 120 and DCD 130A-130N. The CXL memory device controller 115 can have an error correction module to correct the data fetched from the memory arrays in the DCD 130A-130N.

In some embodiments, the local memory 119 can include memory registers storing memory pointers, fetched data, etc. The local memory 119 can also include read-only memory (ROM) for storing micro-code. While the example CXL memory device 110 in FIG. 1 has been illustrated as including the CXL memory device controller 115, in another embodiment of the present disclosure, a CXL memory device 110 does not include a CXL memory device controller 115, and can instead rely upon external control (e.g., provided by an external host, or by a processor or controller separate from the memory sub-system).

In general, the CXL memory device controller 115 can receive commands or operations from the host system 120 or the fabric manager 140 and can convert the commands or operations into instructions or appropriate commands to achieve the desired access to the DCD 130A-130N. The CXL memory device controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical MU address, physical block address) that are associated with the DCD 130A-130N. The CXL memory device controller 115 can further include host interface circuitry to communicate with the host system 120 via the physical host interface. The host interface circuitry can convert the commands received from the host system into command instructions to access the DCD 130A-130N as well as convert responses associated with the DCD 130A-130N into information for the host system 120.

The CXL memory device 110 can also include additional circuitry or components that are not illustrated. In some embodiments, the CXL memory device 110 can include a cache or buffer (e.g., DRAM) and address circuitry (e.g., a row decoder and a column decoder) that can receive an address from the CXL memory device controller 115 and decode the address to access the DCD 130A-130N.

In some embodiments, each or some of DCDs 130A-130N include local media controllers 135 that operate in conjunction with CXL memory device controller 115 to execute operations on one or more memory cells of the DCDs 130A-130N. An external controller (e.g., CXL memory device controller 115) can externally manage the DCDs 130A-130N (e.g., perform media management operations on the memory device 130). In some embodiments, CXL memory device 110 is a managed memory device, which is a raw DCDs 130A-130N having control logic (e.g., local media controller 135) on the die and a controller (e.g., CXL memory device controller 115) for media management within the same memory device package. An example of a managed memory device is a managed NAND (MNAND) device.

In some embodiments, the computing system 100 can include a fabric manager 140.

The fabric manager 140 is an external logical process that queries and configures the operational state of the computing system 100, and may include application logic and policy that makes the assignments of DCDs 130A-130N to the host system 120 at run time. In some embodiments, the fabric manager 140 may be software running on the host system 120, firmware embedded within a Baseboard Management Controller (BMC) on another CXL device or a CXL switch, or a dedicated device running in the CXL device. The fabric manager 140 may assign a (logical) device (e.g., DCDs 130A-130N) to the host system 120 by using command sets through the Component Command Interface (CCI). CCI may be exposed through mailbox registers, which provide the ability to issue a command (“mailbox command”) to the device (e.g., DCDs 130A-130N). In some implementations, each of the DCD 130A-130N can include one or more taggable DC units 136. In the example of FIG. 1, the fabric manager 140 may assign one taggable DC unit to the host system 120 and create a globally unique tag attached to the taggable DC unit as a tagged capacity unit 137; the fabric manager 140 may assign another taggable DC unit to the host system 120 and create a globally unique tag attached to the taggable DC unit as a tagged capacity unit 138. Although specific number of taggable dynamic capacity units is shown in FIG. 1 and taggable dynamic capacity units shown in FIG. 1 have the same size of capacity, various sizes of capacities can be allocated to the taggable dynamic capacity units according to the request of the host systems, and the number of taggable dynamic capacity units included in a DCD can vary. In some implementations, the capacity size of a taggable dynamic capacity unit may be a multiple of a minimum capacity size, and the minimum capacity size may be 2 MB, 0.5 GB, 1 GB, etc. In some implementations, some or all of the functionality of the fabric manager 140 may be performed by the controller 115 and/or a file system component 113.

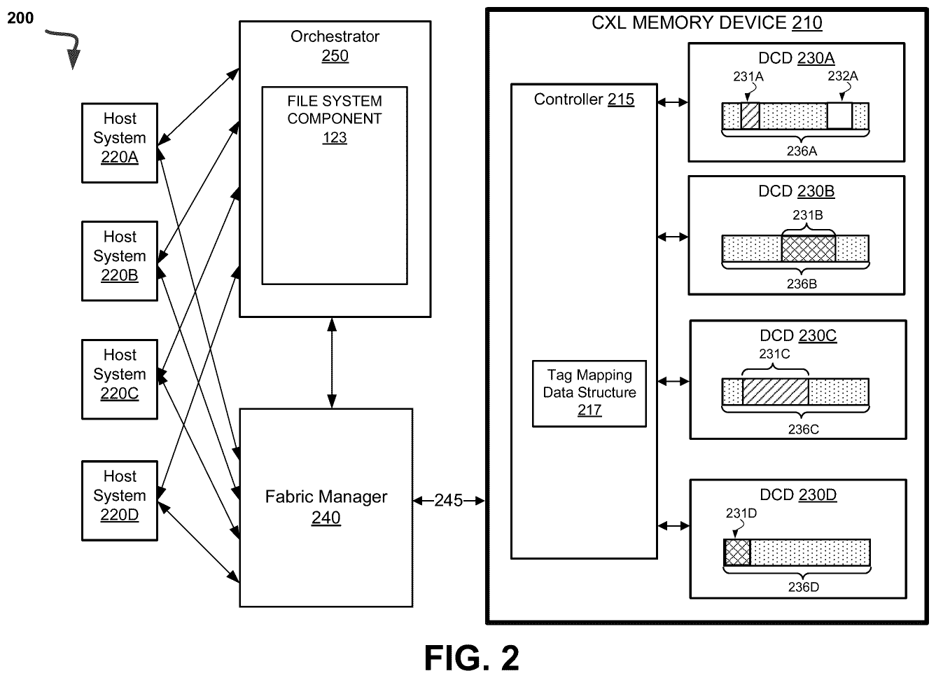

In some embodiments, the host system 120 includes a file system component 123 that enables the host system 120 to implement a file system with tagged capacity in the CXL memory device 110. In some embodiments, the CXL memory device controller 115 includes at least a portion of the file system component 123. In some embodiments, the file system component 123 is part of the CPU 109, an application, or an operating system. In other embodiments, local media controller 135 includes at least a portion of file system component 123 and is configured to perform the functionality described herein. Further details regarding the operations of the file system component 123 are described below with reference to FIGS. 2-6. In some implementations, the tag capacity manager 123 may be included in the orchestrator 250 as shown in FIG. 2.

It will be appreciated by those skilled in the art that additional circuitry and signals can be provided, and that the components of FIG. 1 have been simplified. It should be recognized that the functionality of the various block components described with reference to FIG. 1 may not necessarily be segregated to distinct components or component portions of an integrated circuit device. For example, a single component or component portion of an integrated circuit device could be adapted to perform the functionality of more than one block component of FIG. 1. Alternatively, one or more components or component portions of an integrated circuit device could be combined to perform the functionality of a single block component of FIG. 1.

FIG. 2 is a schematic block diagram of a system 200 implementing taggable dynamic capacity units in a compute express link (CXL) memory device. In various embodiments, the system 200 includes one or more host systems 220A-D (such as the host system 120), a CXL memory device 210 (such as the CXL memory device 110) that includes a controller 215 (such as controller 115), a CXL fabric interconnect 245, a fabric manager 240 that can perform operations managing the CXL fabric interconnect 245, and an orchestrator 250. In some embodiments, aspects of the controller 215 are included in the processing logic of DCDs 230A-230D. The CXL memory device 210 can be connected to the host systems 220A-D via a network connection interface utilizing the high-speed bus (e.g., a Peripheral Component Interconnect Express (PCIe) bus), such as a compute express link (CXL) fabric interconnect 245. The compute express link (CXL) fabric interconnect 245 may provide an interface that can support several protocols that can run on top of PCIe, including a CXL.io protocol, a CXL.mem protocol, and a CXL.cache protocol. The CXL fabric interconnect 245 may be a collection of one or more switches, and each switch is port based routing (PBR) capable and interconnected with PBR links. The CXL fabric interconnect 245 can connect one or more host ports to the devices within a single coherent host physical address (HPA) space.

In the example of FIG. 2, the DCD 230A may include a first region 236A, the DCD 230B may include a second region 236B, the DCD 230C may include a third region 236C, and the DCD 230D may include a fourth region 236D. As shown in FIG. 2, each region of the first region 236A, second region 236B, third region 236C, and fourth region 236D may include one or more taggable dynamic capacity units. Although the regions are illustrated in FIG. 2 as in the uniform size of capacity, the regions can have various capacity sizes.

In some implementations, the orchestrator 250 may control the accessibility to each tag by the host systems 220A-D. The orchestrator 250 may make global control and management decisions about a cluster of the host systems 220A-D. The orchestrator 250 may be responsible for maintaining the desired state (i.e., a state desired by a client when running the cluster) of the host systems 220A-D, such as which applications are running and which container images they use, which resources should be made available for them, and other configuration details. In some implementations, the orchestrator 250 may be a container orchestration system, such as Kubernetes. In some implementations, the orchestrator 250 may be used to provide a containerized computing services platform, such as a Platform-as-a-Service (PaaS) system. The PaaS system provides resources and services (e.g., micro-services) for the development and execution of applications owned or managed by multiple users. A PaaS system provides a platform and environment that allow users to build applications and services in a clustered compute environment (the “cloud”). The orchestrator 250 may include nodes to execute applications and/or processes associated with the applications. A “node” providing computing functionality may provide the execution environment for an application. In some implementations, the “node” may include a virtual machine that is hosted on a physical machine, such as the host system 220A-220D implemented as part of the clouds. In some implementations, nodes may additionally or alternatively include a group of virtual machines, a container, or a group of containers to execute functionality of the PaaS applications. When nodes are implemented as virtual machines, they may be executed by operating systems (OSs) on each host system 220A-220D. Although implementations of the disclosure are described in accordance with a certain type of system, this should not be considered as limiting the scope or usefulness of the features of the disclosure. For example, the features and techniques described herein can be used with other types of multi-tenant systems and/or containerized computing services platforms.

The orchestrator 250 may include a file system component 123. The file system component 123 can manage the storage and retrieval of data in the DCDs 230A-230D through the file system. The file system component 123 can include data structures used to organize the data and can involve separating the data into storage units that can be individually identified and accessed. The file system component 123 can be integrated into a kernel, a user space driver, a device driver, an application, other portion of operating system, or a combination thereof. The file system component 123 can execute as one or more system processes (e.g., kernel processes), user processes (e.g., application processes), or a combination thereof.

The file system component 123 can include multiple layers, including a logical file system (e.g., logical layer), a virtual file system (e.g., virtual layer), a physical file system (e.g., physical layer), or other layers. The logical file system can manage interaction with applications (e.g., through node) and can provide an application program interface (API) (e.g., through CXL fabric 245) that exposes file system operations (e.g., open, close, create, delete, read, write, execute) to other computer programs. The logical layer of file system can manage security and permissions and maintain open file table entries and per-process file descriptors. The logical file system can pass requested operations (e.g., write requests) to one or more other layers for processing. The virtual file system can enable operating system to support multiple concurrent instances of physical file systems, each of which can be referred to as a file system implementation. The physical file system can manage the physical operation of the storage device (e.g., DCDs 230A-230D). The physical file system can handle buffering and manage main memory and can be responsible for the physical placement of storage units in specific locations on the DCDs 230A-230D. The physical file system can include device mapping logic and can interact with device drivers or with the channel to interact with the DCDs 230A-230D. One or more of the file system layers can be explicitly separated or can be combined together in order to store file system data.

File system data can be any data associated with file system and can include data received by file system or data generated by file system. File system data can include data of one or more external file system objects, internal file system objects, or a combination thereof. The external file system objects can be file system objects that are externally accessible by a computer program (e.g., applications) using file system API. The external file system objects can include files (e.g., file data and metadata), directories (e.g., folders), links (e.g., symbolic links, hard links), or other objects. The internal file system objects can be file system objects that remain internal to the file system and are inaccessible using file system API. The internal file system objects can include storage tree objects (e.g., extent map, extent tree, block tree), stream objects (e.g., stream identifiers), file group data (e.g., group of similar files), storage units, block groups, extents, or other internal data structures.

Each file system object can be associated with object data and object metadata. The object data can be the content of the object (e.g., file data). For example, the content may be reflective of a state of the application (e.g., including information that represents the values of the variables, the memory layout, the position of the instruction pointer, and other details about the state of the application). The object metadata can be information about the object (e.g., file metadata). The object metadata can indicate attributes of the object such as a storage location (e.g., zone, block group, storage unit), data source (e.g., stream, application, user), data type (e.g., text, image, audio, video), size (e.g., file size, directory size), time (e.g., creation time, modification time, access time), ownership (e.g., user ID, group ID), permissions (e.g., read, write, execute), file system location (e.g., parent directory, absolute path, local path), other attribute, or a combination thereof.

The object data and object metadata (e.g., attributes, tree nodes) can be stored together in the same data structure at the same storage location or can be stored separately in different data structures at different storage locations. For example, file system can store the object metadata in a log data structure and the log data structure can have one or more entries associated with the object data. Each log entry can indicate the attributes and storage locations (e.g., DPA ranges) of the data of the file system object. A directory can be represented as an entry and can contain an entry for itself, its parent (e.g., parent directory), and each of its children (e.g., child directories or files).

Specifically, the host systems 220A-D, through the node (e.g., an application, a virtual machine), may request to create a file system with tagged capacity in the DCDs 230A-230D of the CXL memory device 210. The file system component 123 can then create a file system in one or more tagged capacity units of the DCDs 230A-230D. In some implementations, creating the file system may involves requesting allocation of a FS tagged capacity unit in the DCDs 230A-230D, creating, in the allocated FS tagged capacity unit, a superblock, and reserving regions of the allocated FS tagged capacity unit for storing the file system object metadata and the file system object data. Creating the superblock may involve storing, in a region (e.g., at the beginning) of the FS tagged capacity unit, information that identifies a producer and verifies that the FS tagged capacity unit contains a file system with tagged capacity. Now illustrating the host system 220A as an example of producer, and the host system 220B as a consumer, creating a file system and adding the file system data of file system with tagged capacity is described in detail below.

The file system component 123 can request the allocation of the FS tagged capacity unit by sending a request to the controller 215. The request may include an allocation request of tagged capacity in DCDs 230A-230D, where the allocation request may specify a capacity size of the tagged capacity. Upon receiving the request, the controller 215 and/or the fabric manager 240 may determine the portions of the DCDs 230A-230D for allocation. In some implementations, the controller 215 may determine an available portion, in the requested capacity size, of the DCDs 230A-230D to be allocated to the host system 220A and request the fabric manager 240 to provide a tag. The controller 215 may receive the tag from the fabric manager 240 and assign the tag to the allocated portion referred to as the tagged capacity unit, for example, the tagged capacity unit 231A, 232A, 231B, 231C, 231D. In some implementations, the fabric manager 240 may determine an available portion, in the requested capacity size, of the DCDs 230A-230D to be allocated to the host system 220A and assign a tag to the allocated portion referred to as the tagged capacity unit, for example, the tagged capacity unit 231B, or the tagged capacity unit 231C. In various implementations, the tag is created by the fabric manager 240 so that the tag is globally unique. The controller 215 may store, in the tag mapping data structure 217, the tag, the DPA ranges of the allocated portions of the DCDs 230A-230D, and the host identifier (or a host group identifier) that defines the host system(s) that can access the tag.

In some implementations, the allocation request may specify a host identifier (or a host group identifier), a region number, a selection policy, etc. The host identifier (or a host group identifier) may identify the host system(s) to which the tag is to be assigned. The region number may identify the region of the DCDs in which the tagged capacity unit associated with a tag is, where the identified region has various attributes, including whether the region is writable or writable/readable or read-only, whether the region has the hardware managed coherency that the most recent copy from a cache line is coherent in the hardware, or whether the region is sharable by one or more host systems. The selection policy may specify the policy for selecting the taggable DC unit of the DCDs as the tagged capacity unit associated with a tag. For example, a “free and contiguous” policy may allow a memory controller (e.g., controller 215) to select a free and contiguous space in the DCDs, while a “prescriptive” policy may allow a fabric manager (e.g., the fabric manager 240) to select a specific extent list in the DCDs.

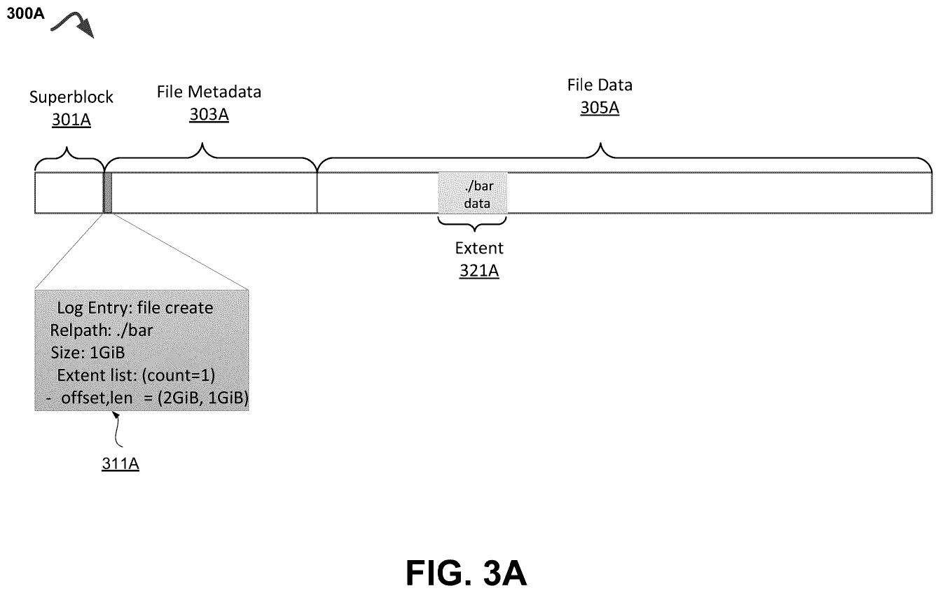

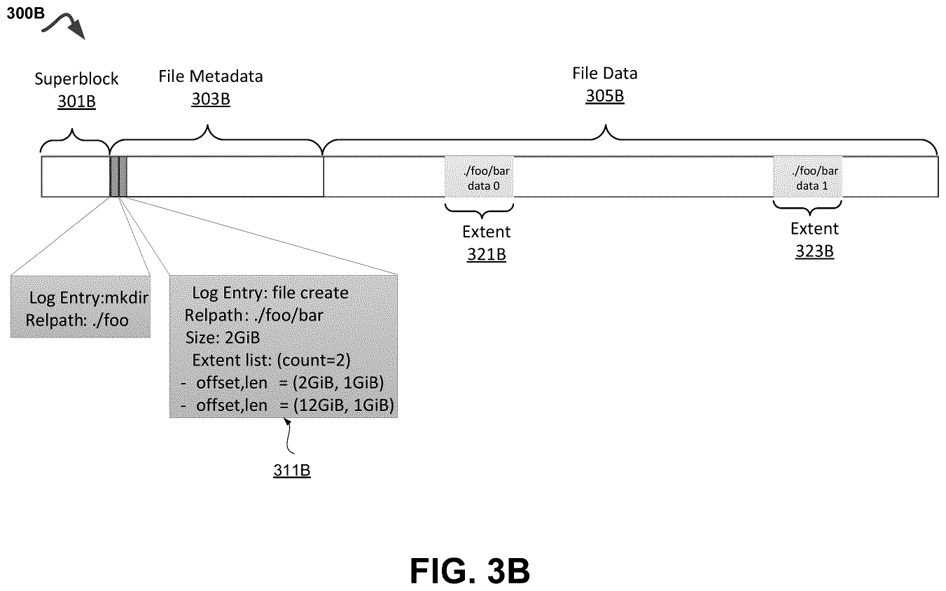

Upon receiving the allocated tagged capacity unit, the file system component 123 can create, in the allocated tagged capacity unit, a superblock, and reserve regions of the allocated tagged capacity unit for storing the file system object metadata and the file system object data. In some implementations, the file system component 123 can partition the tagged capacity unit into multiple portions, where each portion is designated for a specific type of data. For example, the file system component 123 can partition the tagged capacity unit into a superblock portion (e.g., 301A in FIG. 3A, 301B in FIG. 3B), a metadata portion (e.g., 303A in FIG. 3A, 303B in FIG. 3B), and a data portion (e.g., 305A in FIG. 3A, 305B in FIG. 3B), where the superblock portion is designated for a superblock, the metadata portion is designated for object metadata, and the data portion is designated for object data. The portions can be variable-sized.

In some implementations, the superblock portion of the tagged capacity unit can be used as a space (referred to as “superblock”) that contains information to verify that the tagged capacity unit contains a file system with tagged capacity, that is, whether the tagged capacity unit is implemented with the file system. For example, such information may include a magic number and cyclic redundancy check (CRC), which can be used to produce a check value to determine whether the allocated regions contain the file system with tagged capacity.

In some implementations, the metadata and data portions can be used to store object metadata (e.g., log entry, extent tree node, an index node in a file system tree including a reference (e.g., pointer) to storage unit) and object data (e.g., file content, extents), respectively. The file system data can be understood as a contiguous portion a file system object (e.g., a series of LBAs), and portions of the tagged capacity units can be understood as an area of a memory device (e.g., one or more DPA ranges) that is reserved for file system data of a file system. Larger files can be partitioned into the data sets that are individually tracked to make allocation and management of the files feasible over a necessary series of allocation and writes to DCDs 230A-230D. For example, each data set can be associated with a data set identifier. A default ratio of object data to object metadata can be predefined.

The object metadata of a file system object can be written sequentially in a log in the metadata portion of the tagged capacity unit. A log can thus include multiple entries, where each entry can correspond to object metadata to a specific file system object. As the entry is written in the log, the corresponding object data of the file system object can be written to the data portion of the tagged capacity unit as one or more extents. An extent is a contiguous area of storage reserved for a file system object of file system. The object data of each file system object can consist of zero or more extents and each extent can store a fragment, segment, or portion of the object data of the file system object. Each extent can be represented by a one or more numbers (e.g., number pair) and each of the numbers can be a location, position, address, other numeric value, or a combination thereof. In one example, each extent can be represented by a pair of numbers that represent a range of memory space (e.g., beginning and end of a DPA range). The use of extents can also enable the file system to reduce metadata overhead of large files. For example, suppose a large file of 10 gigabytes (GB) is chunked into pieces of 128 megabytes (MB), where each extent represents a 128 MB chuck. Multiples of the 128 MB chunks can be grouped together as extents into an extent map and linked to the large file of 10 GB and the metadata of the large file. The file system component 123 can build and retain extent maps to manage these extents.

In some implementations, the file system component 123 may create a mount point (e.g., directories) for the file system with the tagged capacity. In some implementations, the file system component 123 may mount the file system with the tagged capacity through a mount point so that a host system can access the file system to write or read data. In some implementations, the host systems 220A-D, through the node (e.g., an application, a virtual machine), may mount the file system with tagged capacity in the DCDs 230A-230D of the CXL memory device 210. Mounting a file system creates a binding, for the duration of the mount, between a directory that is already in the file system hierarchy, called the mount point, and the entry point into the file system about to be mounted, called the root of the file system. The mount point directory and the root are connected until unmount time. When a file system is mounted on a mount point, it overlays the contents of the mount point directory, such that files, symbolic links, and subdirectories within the mount point directory are no longer accessible and are hidden until the file system is unmounted. Upon mounting the file system with tagged capacity, the host systems 220A-D, through the node (e.g., an application, a virtual machine), can have knowledge of the mounted file system.

Upon the initial creation of the file system, as shown in FIG. 2, the producer node running on the host system 220A may send a request to store file system data in a taggable capacity unit in DCDs 230A-230D. The taggable capacity unit(s) in DCDs 230A-230D described hereinafter with respect to FIGS. 2, 3A, and 3B are formatted with the file system implemented. Upon receiving the request to store file system data, the controller 215 may write the file data to one portion of the tagged capacity unit associated with the tag and write the file metadata in an entry of a log structure to another portion of the tagged capacity unit associated with the tag. For example, in some implementations, file system data can include data for a new file and the new file can include file data and file metadata. The file data can include the content of the file (e.g., image content, audio content). The file metadata can include one or more attributes of the content (e.g., identifier corresponding to a zone, stream, and/or application). The file data and the file metadata can be stored together in the same tagged capacity unit associated with a tag. The controller 215 may determine that the file system data comprises different data types, wherein a first portion of the file system data comprises file data and a second portion of the file system data comprises file metadata. The controller 215 may select different portions of the first memory section based on the different types of data, wherein one portion (e.g., 305A in FIG. 3A, 305B in FIG. 3B) of the first memory section is designated for data of a file and another portion (e.g., 303A in FIG. 3A, 303B in FIG. 3B) of the first memory section is designated for metadata of the file, and then write the file data to the one portion (e.g., 305A in FIG. 3A, 305B in FIG. 3B) of the first memory section and the file metadata to the other portion (e.g., 303A in FIG. 3A, 303B in FIG. 3B) of the first memory section.

As shown in FIG. 3A, the controller 215 may create a log entry 311A and write the log entry 311A in the file metadata portion 303A of the tagged capacity unit 300A, and write the file data (content of the file) corresponding to the log entry as an extent 321A in the file data region 305A of the tagged capacity unit 300A. The log entry 311A specifies the file data is stored in one extent (e.g., count=1), i.e., extent 321A, and indicates the offset location as the start of the extent and the length of the extent. As shown in FIG. 3B, the controller 215 may create a log entry 311B and write the log entry 311B in the file metadata portion 303B of the tagged capacity unit 300B, and write the file data (content of the file) corresponding to the log entry as extents 321B and 323B in the file data region 305B of the tagged capacity unit 300B. The log entry 311B specifies the file data is stored in two extents (e.g., count=2), i.e., extent 321B and extent 323B, and indicates each of the offset locations as the start of the extents and the length of the extents. The controller 215 can maintain an extent map that links the extent (or combining the two or more extent) to the file represented by a contiguous virtual memory address range.

As such, the producer node may store the file system data in the tagged capacity unit 231A. The controller 215 can map the one or more DPA ranges identifying respective locations containing the data on the CXL memory device 210 with corresponding virtual address ranges in the virtual address space available to the host system 220A (i.e., the virtual/logical address space allocated by a host system to the host application that created the data). As such, the controller 215 can access the data at respective locations identified by a set of corresponding addresses (e.g., contiguous physical address range(s) or extent list of non-contiguous physical address range(s) indicating the locations on the CXL memory device 210 of the data).

As described above, once the producer node creates the file system and adds file system data, a consumer node may request to read the file metadata but cannot modify the file metadata. The consumer node may write or read the file data stored in the tagged capacity unit 231A, but cannot change (e.g., read-only) the file metadata stored in the tagged capacity unit 231A. As such, for file system data stored in a tagged capacity unit, the number of extents and the size of each extent cannot be changed by the consumer node. In some implementations, when receiving a request to change the file metadata form the consumer node, the controller 215 may generate an error notification regarding the request. In some implementations, when receiving a request to change the file data form the consumer node, the controller 215 may modify the file data stored in the data portion of the tagged capacity unit 231A according to the request.

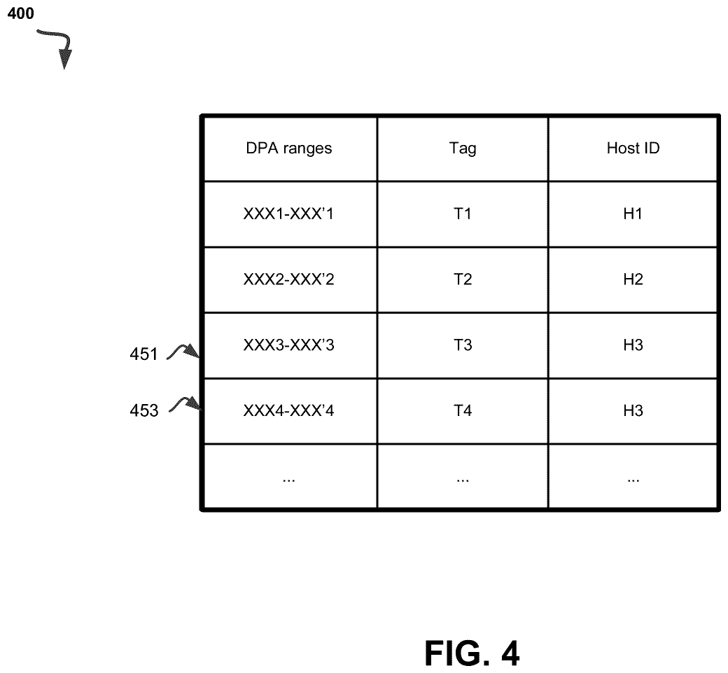

FIG. 4 illustrates an example tag mapping data structure 400 (such as the tag mapping data structure 217) that can be used to implement a file system with tagged capacity. The tag mapping data structure 300B may include an item “DPA ranges,” an item “tag,” and an item “host ID.” The item “DPA ranges” indicates the locations (i.e., one or more physical address ranges of the tagged capacity unit) storing the data on the CXL memory device. The physical address ranges identifying respective locations on the CXL memory device storing the data can be referred to as “the physical address ranges of the tagged capacity unit” containing data. The item “tag” indicates the tag associated with the tagged capacity unit. The item “host ID” indicates the host system from which the tagged capacity unit associated with the tag can be accessed. The mapping data structure 300B may include multiple records (e.g., the record 451, 453), and each record may correspond to a tag, and each record include multiple items as described above.

In view of the item “DPA ranges,” an item “tag,” an item “host ID,” the tag mapping data structure 300B can be used to map the DPA ranges to the host system by mapping the physical address ranges of the tag to corresponding virtual address ranges in a virtual address space of the host system (i.e., the virtual/logical address space allocated by a host system to a host application that is permitted to access the data).

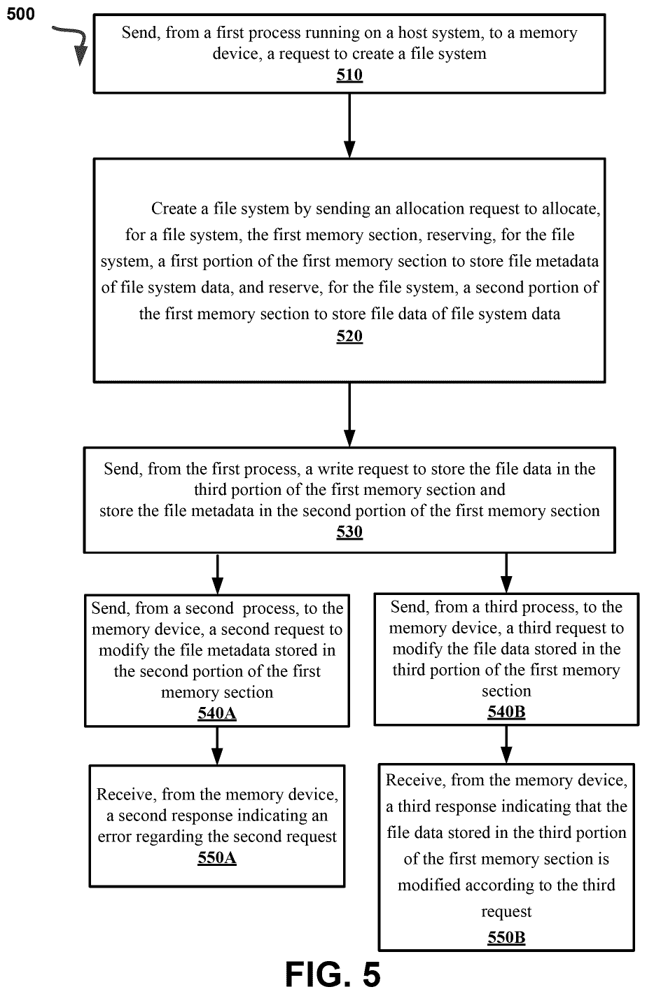

FIG. 5 is a flow diagram of an example method 500 for implementing a file system with tagged capacity in a compute express link (CXL) memory device, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the file system component 123 of FIG. 1 or FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, the processing logic can send, from a first process running on a host system, to a memory device (e.g., the CXL memory device 210), a request to create a file system. In some implementations, the request to create a file system may include a write request to store file system data in the memory device, where the file system data comprises file data and file metadata. In some implementations, the request to create a file system comprises the file system data, in which case the operation 510 can include operation 530 described below.

In some implementations, the memory device (e.g., the CXL memory device 210) comprises a plurality of dynamic capacity devices (e.g., DCD 230A-230D), wherein a first dynamic capacity device (e.g., DCD 230A) of the plurality of dynamic capacity devices comprises a plurality of memory sections comprising a first memory section (e.g., memory section corresponding to 231A).

At operation 520, the processing logic can send an allocation request to allocate, for a file system, the first memory section (e.g., memory section corresponding to 231A), reserve, for the file system, a first portion (e.g., 303A or 303B) of the first memory section for storing file metadata of file system data, and reserve, for the file system, a second portion (e.g., 305A or 305B) of the first memory section for storing file data of file system data.

In some implementations, the processing logic can create a file system by sending an allocation request to allocate, for a file system, a first memory section (e.g., memory section corresponding to 231A) of a plurality of dynamic capacity devices (e.g., DCD 230A-230D) of a memory device (e.g., the CXL memory device 210) allocated to the host system; sending a value for storing the value in a superblock portion (e.g., 301A or 301B) of the first memory section, a value indicating an implementation of the file system in the first memory section; configuring a metadata portion (e.g., 303A or 303B) of the first memory section, the metadata portion being reserved to store file metadata of the file system data; and configuring a data portion (e.g., 305A or 305B) of the first memory section, the data portion being reserved to store file data of the file system data.

In some implementations, the file metadata is stored in an entry of a log in the metadata portion of the first memory section, wherein the log comprises a plurality of entries. In some implementations, the file data is stored in one or more extents in the data portion of the first memory section, wherein the data portion comprises a plurality of extents. In some implementations, the value stored in the superblock portion comprises a flag (e.g., bit) indicating whether the first memory section contains different portions for different data types.

In some implementations, a controller of the memory device can allocate the first memory section and associate a first tag with the first memory section. In some implementations, each of the plurality of dynamic capacity devices comprises a plurality of memory sections, wherein each of the plurality of memory sections is associated with a respective one of a plurality of tags, and wherein each of the plurality of tags is unique. In some implementations, the capacity of the first memory section is immutable and the first tag is immutable until release of the first tag. In some implementations, the first tag is shared by the host system and another host system. In some implementations, the first tag is shared by the first process and another process running on the first host system or another host system. In some implementations, the memory device is a compute express link (CXL) enabled memory device.

In some implementations, a controller of the memory device can receive an allocation request from the host system, where the allocation request specifies a host system and a capacity, allocate the first memory section to the host system, and associate the first tag with the first memory section. In some implementations, a controller of the memory device can create the first tag responsive to receiving the write request by a node in an orchestrator cluster, wherein the node runs on the host system. In some implementations, the processing logic can map the first tag, the first memory section, and an identifier of the host system.

At operation 530, the processing logic can send, by the first process, a write request to store the file data in the data portion of the first memory section and store the file metadata in the metadata portion of the first memory section. The controller of the memory device can store the file metadata of the file system data in the metadata portion of the first memory section and store the file data of the file system data in the data portion of the first memory section. In some implementations, the processing logic can determine that the file system data comprises different data types, wherein a first portion of the file system data comprises file data and a second portion of the file system data comprises file metadata. In some implementations, the file metadata is immutable, and the file data is mutable. In some implementations, the processing logic can select different portions of the first memory section based on the different types of data.

In some implementations, the processing logic can send, by the first process, to the memory device, the file metadata for storing the file metadata in the metadata portion of the first memory section. In some implementations, the controller of the memory device can store the file metadata in an entry of a log in the metadata portion of the first memory section, wherein the log comprises a plurality of entries. In some implementations, the file metadata is an entry of a log, and the entry specifies at least one of: a file creation operation (e.g., an operation creating file data), a file update operation (e.g., an operation modifying file data), or a file access operation (e.g., an operation accessing file data).

In some implementations, the processing logic can send, by the first process, to the memory device, the file data for storing the file data of the file system data in the data portion of the first memory section. In some implementations, the controller of the memory device can store the file data in one or more extents in the data portion of the first memory section stores, wherein the data portion of the first memory section comprises a plurality of extents.

In some implementations, the processing logic can make mutable the file data stored in the data portion and make immutable the file metadata stored in the metadata portion. In some implementations, making mutable the file data stored in the data portion may involve making the file data writable and readable. In some implementations, making immutable the file metadata stored in the metadata portion may involve making the file metadata read-only.

At operation 540A, the processing logic can send, by a second process running on the host system, to the memory device, a second request to modify the file metadata stored in the metadata portion of the first memory section. The controller of the memory device can generate an error notification regarding the second request. At operation 550A, the processing logic can receive, from the memory device, a second response indicating an error regarding the second request.

At operation 540B, the processing logic can send, by a third process running on the host system, to the memory device, a third request to modify the file data stored in the data portion of the first memory section. The controller of the memory device can modify the file data stored in the data portion of the first memory section according to the third request. At operation 550B, the processing logic can receive, from the memory device, a third response indicating that the file data stored in the data portion of the first memory section is modified according to the third request.

Although the second process (consumer) and the third process (consumer) described above are running on a same host system on which the first process (producer) is running, the second process and the third process each can run on different host systems from the first process (producer).

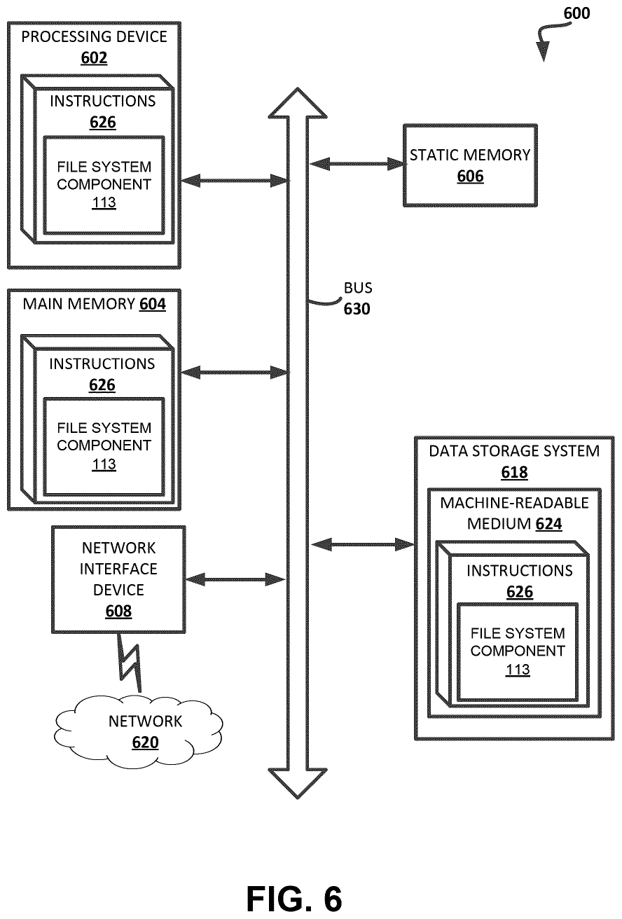

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the CXL memory device 110 of FIG. 1) or can be used to perform the operations of a controller (e.g., to execute an operating system to perform operations corresponding to the file system component 113 of FIG. 1 or the controller 215 (including the file system component 113B) and the fabric manager 240 (including the command component 113A) of FIG. 2). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the CXL memory device 110 of FIG. 1.

In one embodiment, the instructions 626 include instructions to implement functionality corresponding to an APL management component (e.g., the file system component 113 of FIG. 1 or the controller 215 (including the file system component 113B) and the fabric manager 240 (including the file system component 113A) of FIG. 2). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A host system comprising:
a memory and
a processing device, operatively coupled with the memory, to perform operations comprising:
sending, to a memory device, an allocation request to allocate, for a file system, a first memory section of a plurality of memory sections of a plurality of dynamic capacity devices associated with the memory device;
reserving, for the file system, a first portion of the first memory section for storing file metadata of file system data;
reserving, for the file system, a second portion of the first memory section for storing file data of file system data;
sending, by a first process running on the host system, to the memory device, the file metadata for storing the file metadata in the first portion of the first memory section;
sending, by a second process running on the host system, to the memory device, a second request to modify the file metadata stored in the first portion of the first memory section; and
receiving, from the memory device, a second response indicating an error regarding the second request.

2. The system of claim 1, wherein the operations further comprise:
sending, by the first process, to the memory device, the file data for storing the file data of the file system data in the second portion of the first memory section;
sending, by a third process running on the host system, to the memory device, a third request to modify the file data stored in the second portion of the first memory section; and
receiving, from the memory device, a third response indicating that the file data stored in the second portion of the first memory section is modified according to the third request.

3. The system of claim 1, wherein the file metadata is an entry of a log, the entry specifying at least one of: a file creation operation, a file update operation, or a file access operation.

4. The system of claim 1, wherein the file data is stored in one or more extents in the second portion of the first memory section, and wherein the second portion comprises a plurality of extents.

5. The system of claim 1, wherein a value is stored in the first memory section, the value indicating whether the first memory section implements the file system.

6. The system of claim 1, wherein each memory section of the plurality of memory sections is associated with a respective one of a plurality of tags.

7. The system of claim 1, wherein a first tag is assigned to the first memory section, wherein a capacity of the first memory section is immutable, and wherein the first tag is mapped to the first memory section and an identifier of the host system.

8. The system of claim 1, wherein the memory device is a compute express link (CXL) enabled memory device.

9. A method comprising:
sending, by a proceeding device of a host system, to a memory device, an allocation request to allocate, for a file system, a first memory section of a plurality of memory sections of a plurality of dynamic capacity devices associated with the memory device;
reserving, for the file system, a first portion of the first memory section for storing file metadata of file system data;
reserving, for the file system, a second portion of the first memory section for storing file data of file system data;
sending, by a first process running on the host system, to the memory device, the file metadata for storing the file metadata in the first portion of the first memory section;
sending, by a second process running on the host system, to the memory device, a second request to modify the file metadata stored in the first portion of the first memory section; and
receiving, from the memory device, a second response indicating an error regarding the second request.

10. The method of claim 9, further comprising:
sending, by the first process, to the memory device, the file data for storing the file data of the file system data in the second portion of the first memory section;
sending, by a third process running on the host system, to the memory device, a third request to modify the file data stored in the second portion of the first memory section; and
receiving, from the memory device, a third response indicating that the file data stored in the second portion of the first memory section is modified according to the third request.

11. The method of claim 9, wherein the file metadata is an entry of a log, the entry specifying at least one of: a file creation operation, a file update operation, or a file access operation.

12. The method of claim 9, wherein the file data is stored in one or more extents in the second portion of the first memory section, and wherein the second portion comprises a plurality of extents.

13. The method of claim 9, wherein a value is stored in the first memory section, the value indicating whether the first memory section implements the file system.

14. The method of claim 9, wherein each memory section of the plurality of memory sections is associated with a respective one of a plurality of tags.

15. The method of claim 9, wherein a first tag is assigned to the first memory section, wherein a capacity of the first memory section is immutable, and wherein the first tag is mapped to the first memory section and an identifier of the host system.

16. The method of claim 9, wherein the memory device is a compute express link (CXL) enabled memory device.

17. A non-transitory computer-readable storage medium comprising instructions that, when executed by a processing device, cause the processing device to perform operations comprising:
sending, by a proceeding device of a host system, to a memory device, an allocation request to allocate, for a file system, a first memory section of a plurality of memory sections of a plurality of dynamic capacity devices associated with the memory device;
reserving, for the file system, a first portion of the first memory section for storing file metadata of file system data;
reserving, for the file system, a second portion of the first memory section for storing file data of file system data;
sending, by a first process running on the host system, to the memory device, the file metadata for storing the file metadata in the first portion of the first memory section;
sending, by a second process running on the host system, to the memory device, a second request to modify the file metadata stored in the first portion of the first memory section; and
receiving, from the memory device, a second response indicating an error regarding the second request.

18. A non-transitory computer-readable storage medium of claim 17, wherein the operations further comprise:
sending, by the first process, to the memory device, the file data for storing the file data of the file system data in the second portion of the first memory section;
sending, by a third process running on the host system, to the memory device, a third request to modify the file data stored in the second portion of the first memory section; and
receiving, from the memory device, a third response indicating that the file data stored in the second portion of the first memory section is modified according to the third request.

19. A non-transitory computer-readable storage medium of claim 17, wherein the file metadata is an entry of a log, the entry specifying at least one of: a file creation operation, a file update operation, or a file access operation.

20. A non-transitory computer-readable storage medium of claim 17, wherein the file data is stored in one or more extents in the second portion of the first memory section, and wherein the second portion comprises a plurality of extents.
